(19) United States
(12) Patent Application Publication
(10) Pub. No.: US 2025/0131318 A1
(43) Pub. Date: Apr. 24, 2025

(54) MACHINE LEARNING MODEL INTERPRETABILITY FOR SEMI-SUPERVISED MULTIVARIATE ANOMALY DETECTION

(71) Applicant: Oracle International Corporation, Redwood Shores, CA (US)

(72) Inventors: Fang Tu, Shoreline, WA (US); Vesselin Diev, San Antonio, TX (US)

(21) Appl. No.: 18/381,738

(22) Filed: Oct. 19, 2023

(51) Int. Cl. G06N 20/00

(52) U.S. Cl. CPC G06N 20/00

(57) ABSTRACT

Techniques for model interpretability for anomaly detection are provided. In one technique, a machine-learned (ML) model is trained based on training data that comprises first input data and first target data. Using the ML model, (1) first output data is generated based on the first input data and (2) second output data is generated based on second input data. For each data item in the second output data, a difference is generated between the data item and a corresponding data item in second target data that corresponds to the second output data. If the difference is greater than a threshold, then the data item, the corresponding data item, and a corresponding data item in the second input data are identified as an anomalous set. Second training data is generated based on the first training data and the identified anomalous sets and is used to train a second ML model.

### TECHNICAL FIELD

The present disclosure relates to anomaly detection and, more particularly, to interpreting machine-learned anomaly detection models.

### BACKGROUND

With the proliferation of machine learning (ML) models for automating decision-making in many applications, it becomes necessary to understand why such models arrive at these decisions, especially when the decisions have significant consequences. Anomaly detection, as a common use case of machine learning, has found its applications across many different domains, including financial fraud detection, cyber security, policy enforcement, predictive maintenance, medicine, etc. Whether the decisions are to reject a suspicious financial transaction, to catch a policy violation, or to dispatch a field service engineer to repair an equipment predicted to have an imminent failure, rationales behind the decisions by an anomaly detection ML model are critical in understanding, debugging, and improving its predictions.

While many methods have emerged to address model interpretability needs, both locally at a per-instance level and globally at a model level, many of these methods are intended for only supervised machine learning, where sufficient labels (both in quantity and quality) of the adverse event of interest are available for training the models, including in the case of anomaly detection. Unfortunately, many anomaly detection problems do not come with labels or have only scarce or static labels. While normal behavior tends to stay relatively stable over time, in a lot of cases, anomalies can take many different forms and evolve rapidly to render any static labels obsolete. Due to these constraints, semi-supervised anomaly detection techniques are frequently used in anomaly detection applications. The semi-supervised approaches first learn models to approximate/represent typical behaviors, which are much more trackable than dynamically changing anomalous behaviors. The semi-supervised approaches then measure the deviations from such norms and compare the deviations with predefined thresholds to detect anomalies. These semi-supervised approaches have been proven efficient and versatile in detecting dynamic anomalies in multivariate anomaly detection applications.

There have been many recent advancements in addressing the needs of model interpretability for ML models. One recent advancement is LIME, a model-agnostic approach for providing instance-level model explanations. Another recent advancement is SHAP, another model-agnostic approach capable of both instance-level and global model explanations. These approaches are suitable for obtaining explainability for the models learned to approximate/represent normal or typical behaviors. For example, if typical operating conditions are to be represented, such as how an engine works to generate torque, a boosted decision tree regression model is trained to approximate the torque output using engine sensor signals and driver inputs. To get model interpretability for this regression model, SHAP may be used to calculate the Shapley value for each signal used to predict engine torque to estimate how much contribution the signal has to each torque prediction. In addition, these Shapley values can be aggregated across the training data set to obtain the global feature importance for each feature used in the model. However, such model interpretability only explains how each signal contributes to the prediction of typical behaviors. For anomaly detection, model interpretability needs to explain why something is considered as an anomaly, i.e., if there is a significant deviation from the typical behavior for it to be detected as an anomaly, then which signals are contributing to this deviation and how much do they each contribute.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system that provides interpretability for anomaly detection ML models through a model-agnostic surrogate approach, in an embodiment;

FIG. 2A is a block diagram that depicts the training and inference phases in an anomaly detection system, in an embodiment;

FIG. 2B is a block diagram that depicts the generation of surrogate training data, in an embodiment;

FIG. 3 is a block diagram that depicts a process for computing feature attribution values, in an embodiment;

FIG. 4 is a diagram that indicates the relative importance of each feature of a surrogate model using aggregated Shapley values;

FIGS. 5A-5B are a flow diagram that depict an example process for computing feature attribution values, in an embodiment;

FIG. 6 is a block diagram that illustrates a computer system 600 upon which an embodiment of the invention may be implemented;

FIG. 7 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method are provided for model interpretability for semi-supervised multivariate anomaly detection models at both local and global levels. In one technique, interpretability for anomaly detection models is accomplished via a model-agnostic surrogate approach. In this approach, a first ML model is trained based on first training data that comprises first input data and first target data. The first machine-learned model is used to generate, based on the first input data, first output data. The first machine-learned model is also used to generate, based on second input data, second output data. Then, for each data item in the second output data, a difference is generated between the data item and a corresponding data item in second target data that corresponds to the second input data. If the difference is greater than a threshold, then the data item, the corresponding data item in the second target data, and a corresponding data item in the second input data are identified as an anomalous set that is added to a set of anomaly data. After each data item in the second output data is considered, second training data is generated based on the first training data and the set of anomaly data. A second ML model (also referred to as a surrogate model) is trained based on the second training data. Then, based on one or more anomalous sets in the set of anomaly data and the second ML model, a feature attribution is computed for each of one or more features of the second ML model.

Embodiments improve computer-related technology involving model interpretability for semi-supervised models, for which there is a lack of adequate model interpretability tools, especially at the per-instance level. Embodiments involve a unique surrogate model approach to achieve model interpretability for semi-supervised multivariate anomaly detection models. Embodiments are model agnostic and may be applied to many different domains where anomaly detection services are used. Embodiments involve reformulating the model interpretability problem for semi-supervised multivariate anomaly detection ML models as a supervised regression problem, for which state-of-the-art model interpretability techniques, such as SHAP, may be applied. Also, embodiments provide a framework for extracting model explainability at both local and global levels for semi-supervised multivariate anomaly detection ML models.

### System Overview

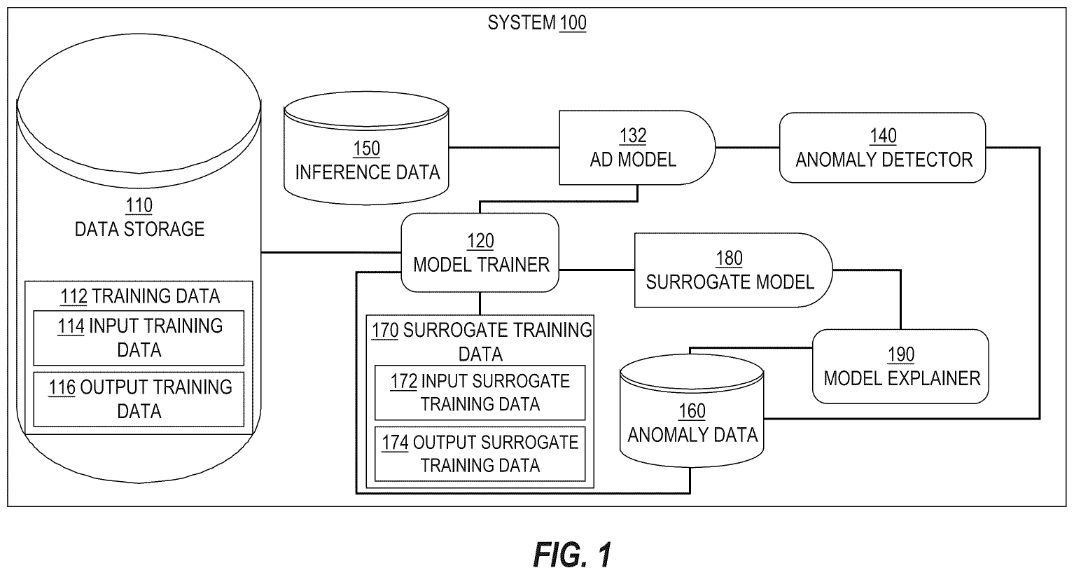

FIG. 1 is a block diagram that depicts an example system 100 that provides interpretability for anomaly detection ML models through a model-agnostic surrogate approach, in an embodiment. System 100 includes data storage 110, a model trainer 120, an anomaly detector 140, inference data 150, anomaly data 160, surrogate training set 170, surrogate model 180, and model explainer 190. Model trainer 120, anomaly detector 140, and model explainer 190 may be implemented in software, hardware, or any combination of software and hardware.

Data storage 110 stores training data 112 that model trainer 120 uses to train anomaly detection (AD) model 132. Data storage 110 also stores, in model storage 130, models that model trainer 120 trains or generates (e.g., AD model 132 and surrogate model 180), inference data 150, and anomaly data 160. While data storage 110 is depicted as a single storage mechanism, data storage 110 may be distributed, such as comprising multiple databases or file systems, which may be on the same local area network (LAN) and/or may be distributed geographically.

In supervised approaches, training data includes a label for each training instance in training data, covering both normal and anomalous cases. However, in embodiments, training data 112 lacks anomalous labels. For example, training data 112 may include thousands of training instances, all with normal labels. Each instance or data item in training data 112 may be one of many types of data, such as user profile data of a user or time series data comprising different input signals originating from a racecar. In the example of time series data, time series data may be of any length of time. For example, a one-minute interval of time series data may be an aggregation of sixty instances of times series data at a one-second interval. An aggregation of multiple instances of time series data may involve a mean, a median, a maximum, a minimum, and/or one or more percentile computations.

Model trainer 120 implements one or more machine learning techniques to produce AD model 132 and surrogate model 180 (described in more detail below). Model trainer 120 may use different machine learning techniques to train AD model 132 and surrogate model 180. For example, model trainer 120 may implement a semi-supervised training technique to train AD model 132 and may implement a supervised training technique (e.g., linear regression) to train surrogate model 180. For example, surrogate model 180 may be a binary classification model or a neural network.

### Anomaly Detection

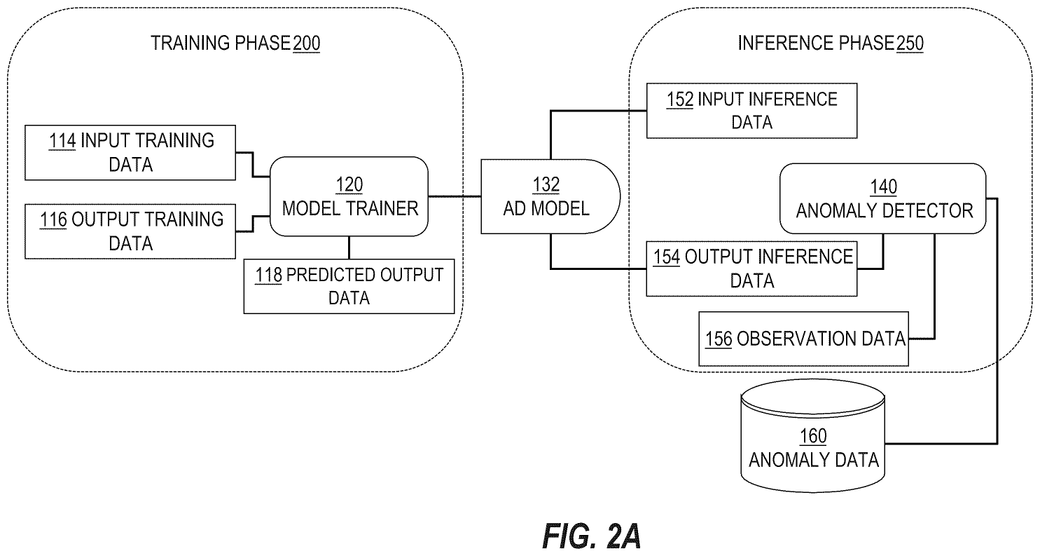

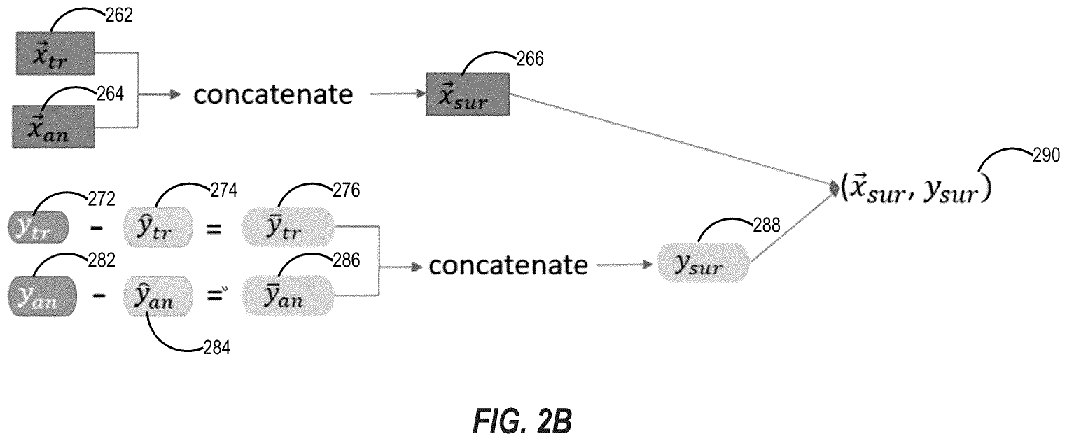

FIG. 2 is a block diagram that depicts the training and inference phases in an anomaly detection system, using elements of FIG. 1, in an embodiment. In training phase 200, model trainer 120 accepts training data 112 (which comprises input training data 114 and output (or “target” training data 116) to train AD model 132. The output of AD model 132 (generated during or after training AD model 132) is predicted output data 118, which is based on input training data 114. Predicted output data 118 comprises multiple output data items, each based on and corresponding to a different input data item from input training data 114.

In inference phase 250, anomaly detector 140 invokes AD model 132 by reading a data item of input inference data 152 (from inference data 150) and inputting that data item into AD model 132. Each data item of input inference data 152 has the same format as the format of data items in input training data 114. The output produced by AD model 132 is stored as output inference data 154. After multiple invocations of AD model 132, output inference data 154 comprises multiple output instances or data items.

Anomaly detector 140 compares each output data item with an actual observation from observation data 156 (in inference data 150). If the difference is greater than a particular threshold, then anomaly detector 140 stores the input data item (that was used to produce the output data item) in anomaly data 160, along with the output data item and the actual observation. These three data items are referred to herein as an “anomalous set.” Anomaly detector 140 stores, in anomaly data 160, each anomalous set.

### Model Interpretability Surrogate Model

Model trainer 120 (or another component of system 100) generates surrogate training data 170 by concatenating at least a portion of input training data 114 with deviations in the output. Surrogate training data 170 is based on input training data 114, output training data 116, and anomaly data 160. In order to generate input surrogate training data 172, a portion of input training data 114 is concatenated with (anomalous) input data items in anomaly data 160.

In order to generate output surrogate training data 174, a difference between individual data items in output training data 116 and corresponding individual data items in predicted output data 118 is generated. (The difference may be a non-binary or floating point difference that involves subtracting one value from another.) For example, if there are one hundred data items in output training data 116, then there are one hundred data items in predicted output data 118 and one hundred calculated differences.

Additionally, for generating output surrogate training data 174, a difference between output data items in anomaly data 160 and corresponding actual observations in anomaly data 160 is generated. For example, if there are ten output data items in anomaly data 160, then there ten actual observations in anomaly data 160 and ten calculated differences.

Both sets of calculated differences are concatenated to generate output surrogate training data 174. These sets of calculated differences are used in order to train a regression model. Thus, in an embodiment, surrogate model 180 is a regression model. In another embodiment, surrogate model 180 is a classification model. That means, instead of subtracting floating point values (or non-binary values) in order generate output surrogate training data 174, the difference that is generated is between two classification labels, such as 0 s and 1s. For example, if a data item in predicted output data 118 is a 0, indicating no anomaly, but a corresponding actual observation is a 1, indicating an anomaly, then a difference between these two values would be the result of (1-0), or 1.

The input training instances in input surrogate training data 172 are matched to the output training instances in output surrogate training data 174 in order to generate surrogate training data 170. Thus, each training instance in surrogate training data 170 includes an input training instance from input surrogate training data 172 and an output training instance from output surrogate training data 174. For example, each anomalous data item from anomaly data 160 corresponds to a different training instance in surrogate training data 170 and each anomalous input data item corresponds to a difference that is based on the output data item that corresponds to the anomalous input data item. Similarly, each input training instance from input training data 114 corresponds to a difference that is based on the output training instance (that corresponds to the input training instance in training data 112) and the data item (in predicted output data 118) that corresponds to the input training instance.

FIG. 2B is a block diagram that depicts the generation of surrogate training data 290, in an embodiment. Original input training data 262 (which corresponds to input training data 114) is concatenated with anomalous input data 264 (which correspond to input inference data 152) in order generate input surrogate training data 266 (which corresponds to input surrogate training data 172). A difference between output training data 272 and predicted output data 274 is calculated, resulting in non-anomalous difference data 276. Similarly, a difference between anomalous observation data 282 and anomalous output data 284 is calculated, resulting in anomalous difference data 286. The non-anomalous difference data 276 is concatenated with anomalous difference data 286 to generate output surrogate training data 288. The input surrogate training data 266 is combined with output surrogate training data 288 in order to generate surrogate training data 290 (which corresponds to surrogate training data 170).

Model trainer 120 (or another component of system 100) trains surrogate model 180 based on surrogate training data 170. Based on the values in output surrogate training data 174, surrogate model 180 is trained to estimate deviations using input signals, as in a regression problem. Surrogate model 180 may be a gradient boosted decision tree or any other regression model, including a neural network.

### Feature Attribution

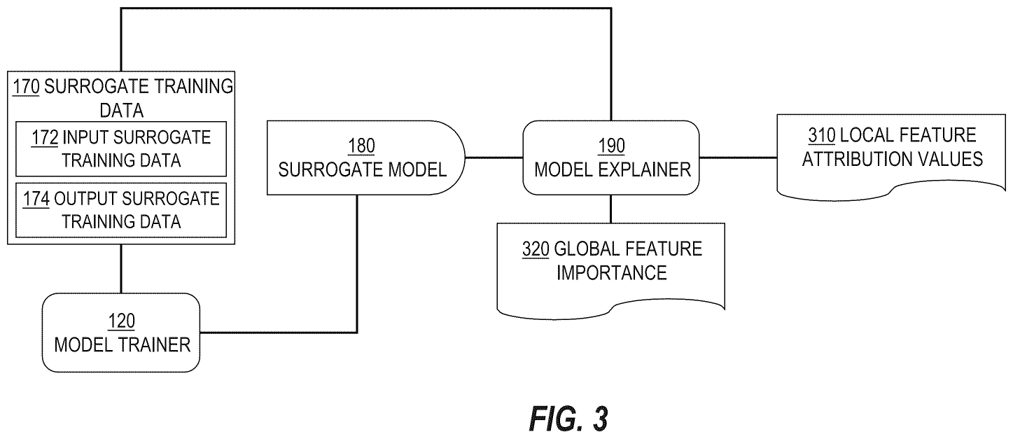

FIG. 3 is a block diagram that depicts a process 300 for computing feature attribution values using model explainer 190, in an embodiment. Model explainer 190 takes, as input, (1) surrogate model 180 and (2) the anomalous training instances in surrogate training data 170. For each anomalous training instance from surrogate training data 170, model explainer 190 generates a set of local feature attribution values 310, each feature attribution value corresponding to a different feature in (or input signal of) surrogate model 180. A feature attribution value is an estimate of how the overall deviation of each anomaly can be attributed to each feature.

An example of model explainer 190 is a SHAP (SHapley Additive explanations) explainer. SHAP is a game theoretic approach to explain the output of any machine-learned model. In this embodiment, model explainer 190 computes a Shapley value for each input signal (corresponding to a feature of surrogate model 180), given an anomalous training instance in surrogate training data 170. A Shapley value is an estimate of how the overall deviation of each anomaly can be attributed to each input signal. Thus, given a single anomalous training instance from surrogate training data 170, model explainer 190 generates a set of Shapley values, one Shapley value for each input signal/feature.

After sets of feature attribution (e.g., Shapley) values are generated based on a set of anomalous training instances, model explainer 190 (or another component of system 100) generates a global feature importance 320 for each feature of surrogate model 180, based on the set of local feature attribution values 310. For example, if there are ten features of surrogate model 180 and twenty anomalous training instances, then model explainer 190 would generate twenty sets of Shapley values, each comprising ten Shapley values. Thus, there are twenty Shapley values for the first feature of surrogate model 180, twenty Shapley values for the second feature of surrogate model 180, and so forth. The twenty Shapley values for the first feature are aggregated to generate a global feature importance for the first feature. Examples of aggregation include mean, median, max, min, and another percentile value, such as 90^{th} percentile.

In an embodiment, after the feature attribution (e.g., Shapley) values are aggregated for each feature of surrogate model 180, the features of surrogate model 180 are ranked or ordered based on their respective feature attribution values. The aggregated values and/or the feature rankings provide insights into why the anomalous training instances were detected as anomalies, what the top contributing input signals are, and how much those input signals are contributing.

In an embodiment, names of the features of surrogate model 180 are displayed on a screen of a computing device along with the aggregated values and/or rankings of the features of surrogate model 180. For example, system 100 transmits the feature names and aggregated values/rankings over a computer network (e.g., a local area network or the Internet) to a computing device. The aggregated values/rankings are displayed corresponding to their respective feature names. Examples of the computing device include a laptop computer, a desktop computer, a tablet computer, and a smartphone.

In an embodiment, a percentage is computed for each feature of surrogate model 180 for which an aggregated value is generated. The percentage of a feature is a ratio of the feature's aggregated value to the total of all aggregated values of all the features for which an aggregated value is generated. Such a set of percentages not only reflects which features of surrogate model 180 have the highest importance, but the set of percentages also indicate how much more (or less) important each feature is from the other features of surrogate model 180.

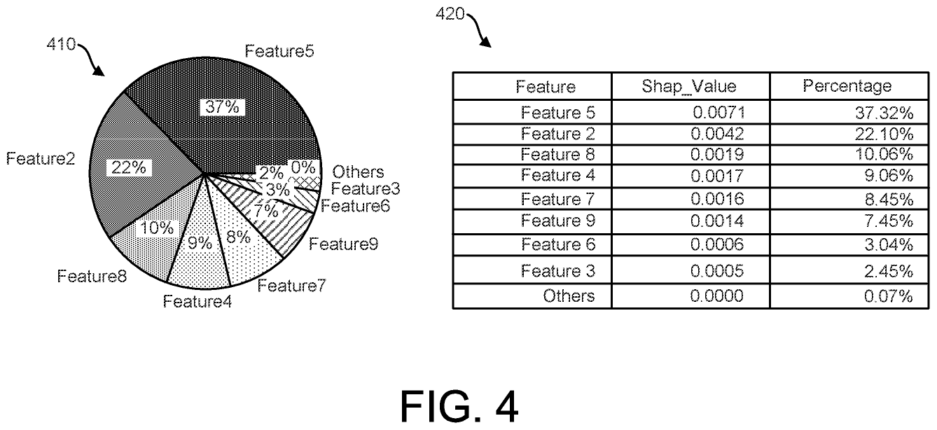

FIG. 4 is a diagram that indicates the relative importance of each feature of surrogate model 180 using aggregated Shapley values. The indication of relative importance is depicted through a pie chart 410 and through a table 420, each of which includes a name of a feature and a relative importance percentage of that feature. Table 420 also includes the aggregated values.

### Example Process

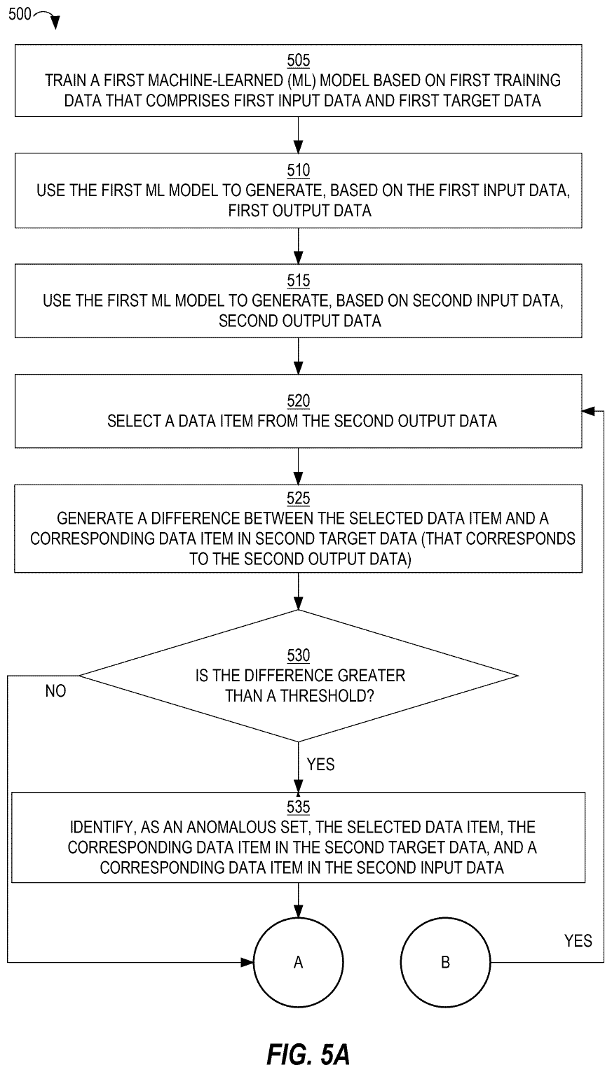

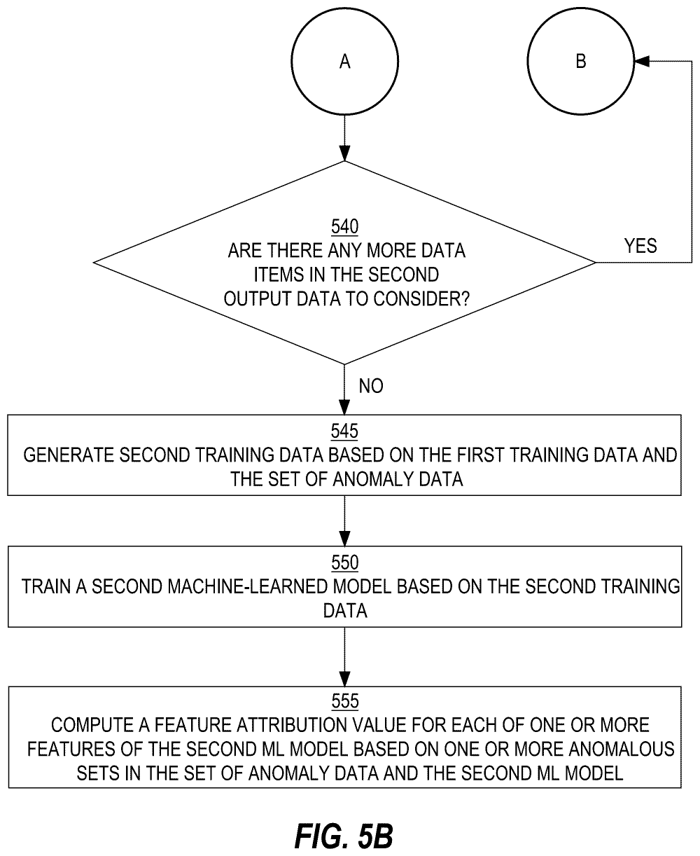

FIGS. 5A-5B are flow diagram that depict an example process 500 for computing feature attribution values, in an embodiment. Process 500 may be implemented by different components of system 100.

At block 505, a first machine-learned (ML) model is trained based on first training data that comprises first input data and first target data. The first input data represents input signals. The first ML model may be considered a base model that is trained using zero to few labels, as indicated in the first target data.

At block 510, the first ML model is used to generate, based on the first input data, first output data. Block 510 may involve, after the first ML model is trained, inputting the first input data into the first ML model, which outputs the first output data. Thus, if there are one thousand data items in the first input data, then there are one thousand data items in the first output data. Block 510 may involve inputting only a strict subset of the first input data into the first ML model in order to generate the first output data.

At block 515, the first ML model is used to generate, based on second input data, second output data. This second input data is different than the first input data, which is part of the training data that was used to train the first ML model. The second input data may be considered inference data.

At block 520, a data item from the second output data is selected. Block 520 may involve a random selection. Alternatively, block 520 may involve selecting the data items from the second output data in an order in which the data items in the second output data appear.

At block 525, a difference between the selected data item and a corresponding data item in second target data (that corresponds to the second output data) is generated. The second target data comprises data items, each of which is an actual observation. Thus, if the first ML model is used to predict torque, the second target data may comprise actual torque measurements at different points in time. The generated difference may be the actual difference or an absolute difference.

At block 530, it is determined whether the generated difference is greater (or lesser) than a particular threshold. The particular threshold may be defined by a user, which threshold may reflect the user's understanding of an acceptable difference before an anomaly is detected. If the determination in block 530 is in the affirmative, then process 500 proceeds to block 535. Otherwise, the process 500 proceeds to block 540.

At block 535, the selected data item, the corresponding data item in the second target data, and a corresponding data item in the second input data are identified as an anomalous set. Block 535 also involves adding the anomalous set to a set of anomaly data.

At block 540, it is determined whether there are any more data items to consider in the second output data. If so, then process 500 returns to block 520. Otherwise, process 500 proceeds to block 545.

At block 545, second training data is generated based on the first training data and the set of anomaly data. Block 545 may involve concatenating the first input data with the data items (in the second input data) that are in the set of anomaly data. This concatenating is with respect to input signals. Block 545 may also involve (a) generating first difference data by differencing the first target data with the first output data and (b) generating second difference data by differencing the anomalous data items in the second output data with the corresponding anomalous data items in the second target data. The first difference data and the second difference data are added to the concatenated input signal data in order to produce the second training data. The first difference data and the second difference data act as labels to the concatenated input signal data.

At block 550, a second machine-learned model is trained based on the second training data. The second ML model is considered a surrogate model that is used to estimate deviations given input signals. Block 550 may involve implementing one or more supervised machine learning techniques with respect to the second training data.

At block 555, based on one or more anomalous sets in the set of anomaly data and the second machine-learned model, a feature attribution value is computed for each of one or more features of the second machine-learned model. An example of the feature attribution value is a Shapley value. Block 555 may involve computing a different feature attribution value for each feature of the second ML model and, optionally, computing multiple feature attribution values for each of multiple features of the second ML model.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

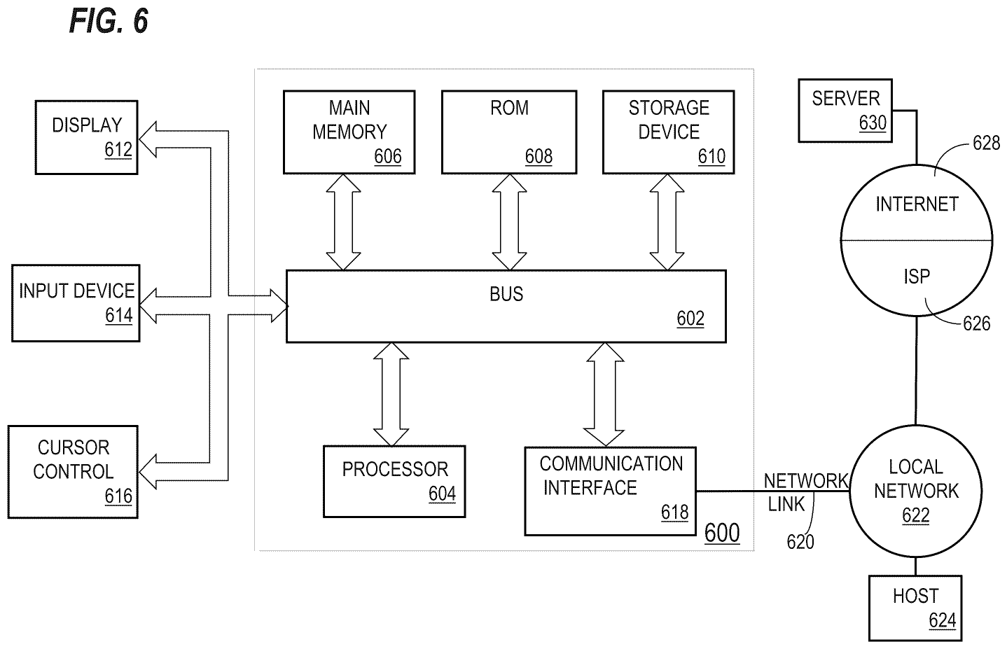

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### Software Overview

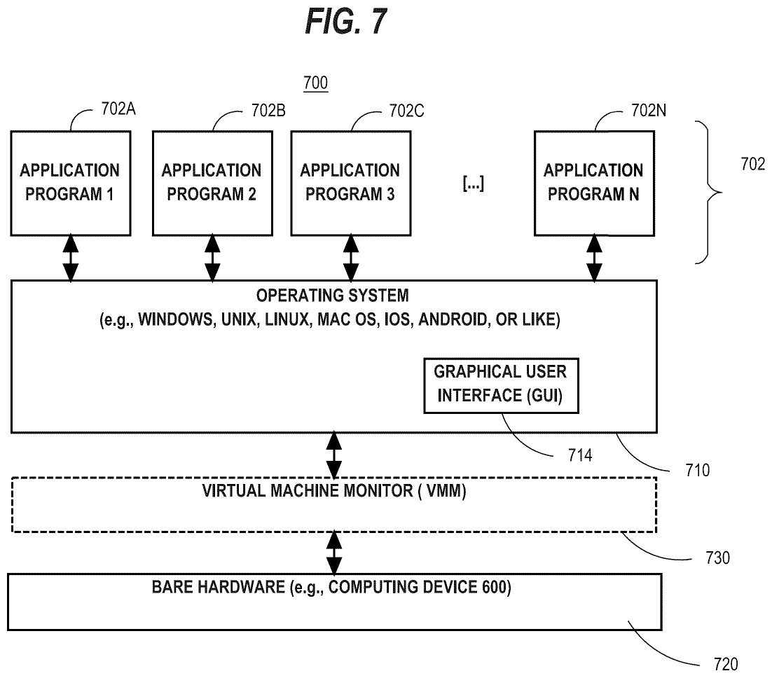

FIG. 7 is a block diagram of a basic software system 700 that may be employed for controlling the operation of computer system 600. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computer system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by the system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by the system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 600 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
training a first machine-learned model based on first training data that comprises first input data and first target data;
generating, using the first machine-learned model, based on the first input data, first output data;
generating, using the first machine-learned model, based on second input data, second output data;
for each data item in the second output data:
generating a difference between said each data item and a corresponding data item in second target data that corresponds to the second output data;
if the difference is greater than a particular threshold:
identifying, as an anomalous set, said each data item, the corresponding data item in the second target data, and a corresponding data item in the second input data;
adding the anomalous set to a set of anomaly data;
generating second training data based on the first training data and the set of anomaly data;
training a second machine-learned model based on the second training data;
based on one or more anomalous sets in the set of anomaly data and the second machine-learned model, computing a feature attribution value for each of one or more features of the second machine-learned model;
wherein the method is performed by one or more computing devices.

2. The method of claim 1, wherein generating the second training data comprises:
for each anomalous set in the set of anomaly data:
computing a difference between (1) a data item from the second output data and (2) a corresponding data item in the second target data;
including the difference in a training instance;
adding the training instance to the second training data.

3. The method of claim 1, wherein generating the second training data comprises:
for each data item in the first target data:
computing a difference between (1) said each data item in the first target data and (2) a corresponding data item in the first output data;
including the difference in a training instance;
adding the training instance to the second training data.

4. The method of claim 1, wherein the second machine-learned model is a regression model.

5. The method of claim 1, wherein computing the feature attribution for each of the one or more features of the second machine-learned model comprises computing a feature attribution for each feature of the second machine-learned model.

6. The method of claim 1, wherein the first feature attribution value is a Shapley value.

7. The method of claim 1, wherein computing the feature attribution value is performed for a plurality of anomalous sets in the set of anomaly data, wherein a plurality of feature attribution values are generated for a particular feature of the second machine-learned model, the method further comprising:
performing an aggregation operation on the plurality of feature attribution values to generate a global value for the particular feature.

8. The method of claim 7, wherein the aggregation operation is a mean operation or a median operation.

9. The method of claim 1, wherein computing the feature attribution value is performed for a plurality of anomalous sets in the set of anomaly data, wherein a plurality of feature attribution values is generated for each feature of a plurality of features of the second machine-learned model, the method further comprising:
for each feature of the plurality of features, performing an aggregation operation on the plurality of feature attribution values that correspond to said each feature to generate a global value for said each feature.

10. The method of claim 9, further comprising:
ranking the plurality of features based on the global value for each feature in the plurality of features.

11. The method of claim 9, further comprising:
causing, to be displayed, on a screen of a computing device, a name for each feature of the plurality of features and the global value for each feature in the plurality of features.

12. One or more non-transitory storage media storing instructions which, when executed by one or more computing devices, cause:
training a first machine-learned model based on first training data that comprises first input data and first target data;
generating, using the first machine-learned model, based on the first input data, first output data;
generating, using the first machine-learned model, based on second input data, second output data;
for each data item in the second output data:
generating a difference between said each data item and a corresponding data item in second target data that corresponds to the second output data;
if the difference is greater than a particular threshold:
identifying, as an anomalous set, said each data item, the corresponding data item in the second target data, and a corresponding data item in the second input data;
adding the anomalous set to a set of anomaly data;
generating second training data based on the first training data and the set of anomaly data;
training a second machine-learned model based on the second training data;
based on one or more anomalous sets in the set of anomaly data and the second machine-learned model, computing a feature attribution value for each of one or more features of the second machine-learned model;
wherein the method is performed by one or more computing devices.

13. The one or more storage media of claim 12, wherein generating the second training data comprises:
for each anomalous set in the set of anomaly data:
computing a difference between (1) a data item from the second output data and (2) a corresponding data item in the second target data;
including the difference in a training instance;
adding the training instance to the second training data.

14. The one or more storage media of claim 12, wherein generating the second training data comprises:
for each data item in the first target data:
computing a difference between (1) said each data item in the first target data and (2) a corresponding data item in the first output data;
including the difference in a training instance;
adding the training instance to the second training data.

15. The one or more storage media of claim 12, wherein computing the feature attribution for each of the one or more features of the second machine-learned model comprises computing a feature attribution for each feature of the second machine-learned model.

16. The one or more storage media of claim 12, wherein the first feature attribution value is a Shapley value.

17. The one or more storage media of claim 12, wherein computing the feature attribution value is performed for a plurality of anomalous sets in the set of anomaly data, wherein a plurality of feature attribution values are generated for a particular feature of the second machine-learned model, wherein the instructions, when executed by the one or more computing devices, further cause:
performing an aggregation operation on the plurality of feature attribution values to generate a global value for the particular feature.

18. The one or more storage media of claim 17, wherein the aggregation operation is a mean operation or a median operation.

19. The one or more storage media of claim 12, wherein computing the feature attribution value is performed for a plurality of anomalous sets in the set of anomaly data, wherein a plurality of feature attribution values is generated for each feature of a plurality of features of the second machine-learned model, wherein the instructions, when executed by the one or more computing devices, further cause:
for each feature of the plurality of features, performing an aggregation operation on the plurality of feature attribution values that correspond to said each feature to generate a global value for said each feature.

20. The one or more storage media of claim 19, wherein the instructions, when executed by the one or more computing devices, further cause:
causing, to be displayed, on a screen of a computing device, a name for each feature of the plurality of features and the global value for each feature in the plurality of features.
